(19) United States
(12) Patent Application Publication
(10) Pub. No.: US 2022/0089092 A1
(43) Pub. Date: Mar. 24, 2022

(54) MIRROR ASSEMBLY WITH PASSENGER CAMERA

(71) Applicant: GENTEX CORPORATION, Zeeland, MI (US)

(72) Inventors: Bradley R. Hamlin, Allendale, MI (US); Richard T. Fish, Hudsonville, MI (US)

(73) Assignee: GENTEX CORPORATION, Zeeland, MI (US)

(21) Appl. No.: 17/481,711

(22) Filed: Sep. 22, 2021

Related U.S. Application Data
(60) Provisional application No. 63/082,445, filed on Sep. 23, 2020.

(51) Int. Cl. B60R 1/12; B60R 1/04

(52) U.S. Cl. CPC B60R 1/12; B60R 2001/1253; B60R 1/04

(57) ABSTRACT

A mirror assembly for a vehicle comprises a housing forming a top portion and a bottom portion extending laterally between two side portions. A mirror element is in connection with and encloses a front portion of the housing. The mirror element forms a cutout portion extending along one side. The cutout portioned forming a notched edge having a notched profile. The bottom portion of the housing forms a recessed portion aligned with the notched profile. The assembly further comprises a camera apparatus disposed in a hooded trim panel in connection with the housing and positioned at least partially within the recessed portion. The recessed portion positions the camera apparatus at least partially within a perimeter profile of the mirror element.

### CROSS REFERENCE TO RELATED APPLICATIONS

This application claims the benefit of and priority to U.S. Provisional Patent Application No. 63/082,445, filed on Sep. 23, 2020, entitled Mirror Assembly with Passenger Camera, the entire disclosure of which is hereby incorporated herein by reference.

### TECHNOLOGICAL FIELD

The present invention concerns rearview mirrors and more particularly relates to an interior rearview mirror assembly including a vehicle interior camera apparatus.

### SUMMARY OF THE INVENTION

According to an aspect, a mirror assembly for a vehicle comprises a housing forming a top portion and a bottom portion extending laterally between two side portions; a mirror element in connection with and enclosing a front portion of the housing, the mirror element forming a cutout portion extending along one side, the cutout portion forming a notched edge having a notched profile, wherein the bottom portion of the housing forms a recessed portion aligned with the notched profile; a camera apparatus disposed in a hooded trim panel in connection with the housing and positioned at least partially within the recessed portion of the housing, wherein the recessed portion positions the camera apparatus at least partially within a perimeter profile of the mirror element; and a lens panel in connection with the hooded trim panel and in front of an optical assembly of the camera apparatus. The cutout portion extends through the mirror element and the housing from a front surface of the mirror element to a rear surface of the housing.

The lens panel may be of one of a transflective material and a transparent material. The lens panel may be less than 0.8 mm in thickness. The hooded trim panel may comprise a hood configured to form a rectangular dome extending from the recessed portion into the cutout portion. The cutout portion may extend through the mirror element and the housing from a front surface of the mirror element to a rear surface of the housing.

According to an aspect, a mirror assembly for a vehicle may comprise a housing forming a top portion and a bottom portion extending laterally between two side portions; a mirror element in connection with and enclosing a front portion of the housing, the mirror element forming a cutout portion extending along one side, the cutout portion forming a notched edge having a notched profile, wherein the bottom portion of the housing forms a recessed portion aligned with the notched profile; and a camera apparatus disposed in a hooded trim panel in connection with the housing and positioned at least partially within the recessed portion of the housing. The recessed portion may position the camera apparatus at least partially within a perimeter profile of the mirror element.

The mirror assembly may further comprise a lens panel in connection with the hooded trim panel and in front of an optical assembly of the camera apparatus. The lens panel may be of one of a transflective material and a transparent material. The lens panel may be less than 2 mm in thickness. The lens panel may be less than 0.8 mm in thickness. The mirror element may comprise a transflective electrochromic mirror element configured to vary in reflectance. The hooded trim panel may comprise a hood configured to form a rectangular dome extending from the recessed portion into the cutout portion. The cutout portion extends through the mirror element and the housing from a front surface of the mirror element to a rear surface of the housing.

An image sensor of the camera apparatus may be configured to generate image data, the image data to be processed by a controller. The image data may be processed in relation to a biometric authentication process. The biometric authentication process may be one of facial recognition and iris recognition. The image data may be processed in relation to one of a driver monitoring process and a passenger compartment monitoring process.

These and other features, advantages, and objects of the present device will be further understood and appreciated by those skilled in the art upon studying the following specification, claims, and appended drawings.

### BRIEF DESCRIPTION OF THE DRAWINGS

The invention will now be described with reference to the following drawings, in which;

FIG. 1A is a front view of an interior mirror assembly including a passenger compartment camera;

FIG. 1B is a rear view of an interior mirror assembly including a passenger compartment camera;

FIG. 2A is a front projected view of an interior mirror assembly including a passenger compartment camera;

FIG. 2B is a rear projected view of an interior mirror assembly including a passenger compartment camera;

FIG. 3 is an exploded assembly view of an interior mirror assembly including a passenger compartment camera; and

FIG. 4 is a block diagram of an interior mirror assembly including a passenger compartment camera in accordance with the disclosure.

### DETAILED DESCRIPTION OF EMBODIMENTS

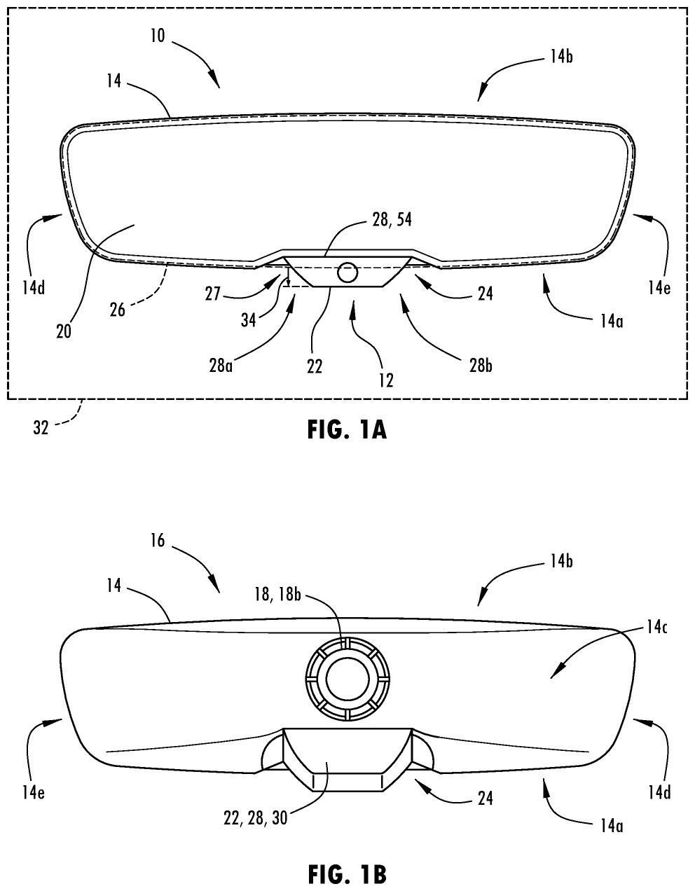

Referring generally to FIGS. 1A-3, the disclosure provides for an interior mirror assembly 10 including an integrated camera apparatus 12 configured to capture image data in a passenger compartment of a vehicle. As shown, the camera apparatus 12 is incorporated in a housing 14 of the mirror assembly 10 connected to the vehicle via a mounting bracket 16. The mounting bracket 16 may adjustably connect the housing 14 to a mounting surface, which may comprise a windshield, roof portion, or headliner of the vehicle via a mounting assembly 18. The mounting assembly 18 may be formed by a ball 18a and a socket 18b, which allow a mirror element 20 and the camera apparatus 12 to be adjustably oriented relative to the passenger compartment of the vehicle. In this way, a front surface 20a of the mirror element and a field of view of the camera apparatus 12 may be oriented such that the reflection and the field of view are variably directed into the passenger compartment.

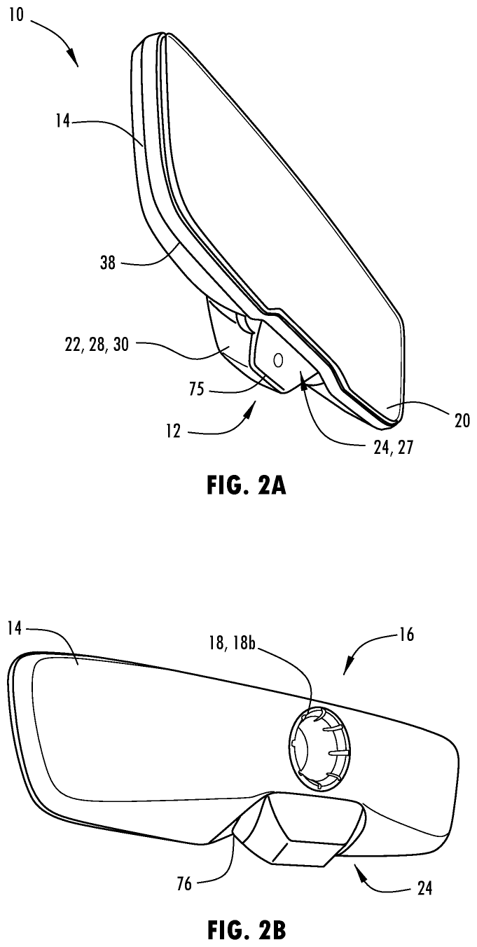

As depicted in FIG. 1A, a bottom surface 14a of the housing 14 may comprise a recessed portion 24. The camera apparatus 12 may be housed within a trim panel 22 in connection with the recessed portion 24 of housing 14. The recessed portion 24 of the housing 14 is apparent in FIG. 1A and forms deviation from an otherwise smooth or consistent perimeter profile 26 extending along the bottom surface 14a. The recessed portion 24 of the housing 14 extends through the mirror element 20 as a cutout portion 27 resulting in a notched edge 28 formed in the mirror element 20. From the recessed portion 24 of the bottom surface 14a, the trim panel 22 protrudes outward forming a hood 28 configured to house and enclose the camera apparatus 12 in connection with the housing 14. The hood 28 forms a rounded rectangular dome 30 that extends from the recessed portion 24 into the cutout portion 27. As depicted in FIGS. 1A, 2A, and 2B, a smooth, contoured portion of the perimeter profile 26 extends along a top surface 14b and extends from a rear surface 14c. The hood 28 is centrally positioned between side portions 14d and 14e of the housing 14.

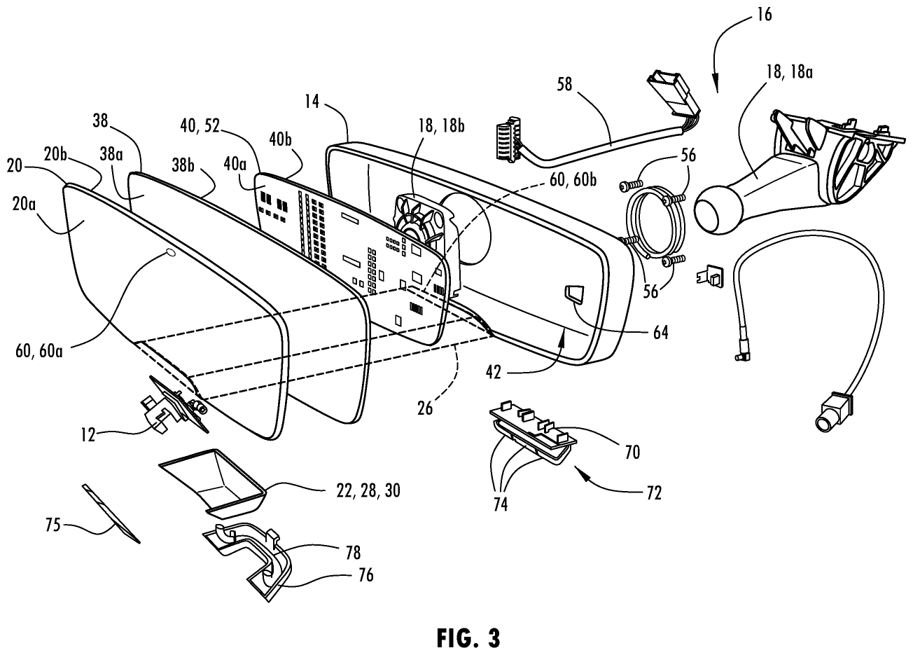

The configuration of the hood 28 within the recessed portion 24 provides for the trim panel 22 to house the camera apparatus 12 while limiting an extent to which a forward line of sight or window of visibility 32 (FIG. 1A) is encumbered by the hood 28. The window of visibility 32 may correspond to a forward view of a passenger or operator of the vehicle through a front windscreen. As shown in FIGS. 1A and 1B, the vertical proportion of the cutout portion 27 may directly adjust a height of the mirror apparatus 12 and result in a decrease in an extent 34 to which the camera apparatus 12 and the hood 28 extend beyond or below the perimeter profile 26 and into the window of visibility 32. As shown in FIGS. 2A and 3, the cutout portion 27 may form a negative extruded profile extending through the mirror element 20, a mounting or carrier plate 38, and the housing 14 from the front surface 20a of the mirror element 20 to the rear surface 14c of the housing 14.

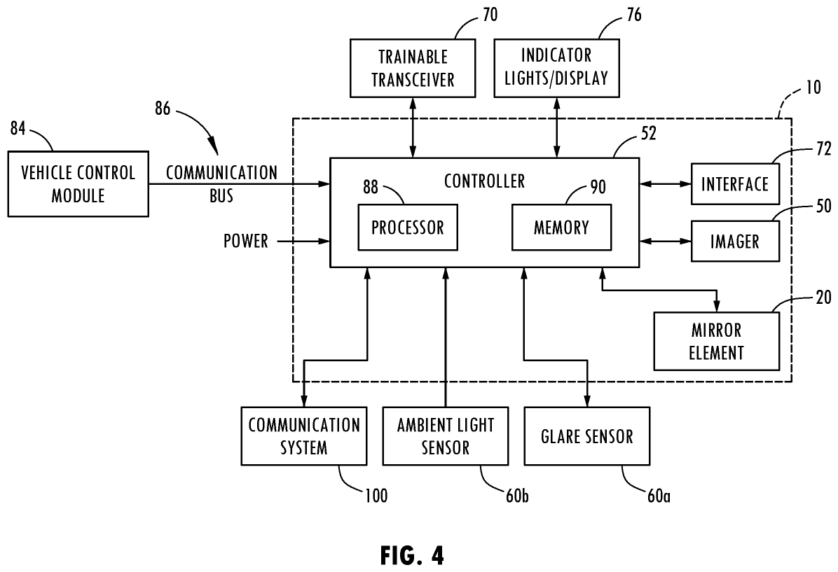

In operation, an imager 50 or image sensor of the camera apparatus 12 generates image data, which may be processed by a controller 52 of the mirror assembly 10 or a connected device as later discussed in reference to FIG. 4. The image data may be processed in relation to a biometric authentication process (e.g., facial or iris recognition) or to monitor activity in the passenger compartment of the vehicle. For example, the camera apparatus 12 may be utilized for driver monitoring to detect sleepiness, inattentiveness, and other driver states. Additionally, the camera apparatus 12 may be configured to detect an occupancy or passenger behavior for rideshare monitoring and/or security purposes. Accordingly, the camera apparatus 12 positioned within the hood 28 and extending outward from the recessed portion 24 of the housing 14 may provide for the capture of image data depicting a scene within or proximate to the passenger compartment.

Still referring to FIGS. 1-3, the mirror assembly 10 provides for the support and selective orientation of the camera apparatus 12 and the mirror element 20. As previously discussed, the mounting bracket 16 adjustably connects the housing 14 to a mounting surface, which may comprise a windshield, roof portion, or headliner of the vehicle via a mounting assembly 18. The mounting assembly 18 may comprise a ball 18a and a socket 18b, which connect to the housing 14 and the mirror element 20 via the carrier plate 38. A circuit board 40 (e.g. a printed circuit board [PCB]) is disposed within the mirror assembly and is enclosed between the mirror element 20 and the housing 14. The housing 14 may comprise a rear panel forming a pocket 42 configured to enclose the circuit board 40 and the carrier plate 38 and to abut a beveled or ground edge of the mirror element 20. In this configuration, the front surface 20a of the mirror element 20 may form a mirror perimeter 54 extending along the perimeter profile 26 along the top surface 14b and side portions 14d and 14e of the housing 14. The mirror perimeter 54 of the mirror element 20 may further include notched edge 28 providing for the cutout portion 27 and opening configured to receive the trim panel 22 of the hood 28.

The mirror assembly 10 may be affixed to the socket 18b of the mounting bracket 18 by a plurality of fasteners 56. As further discussed in reference to FIG. 4, the circuit board 40 may be in communication with a power supply and a communication bus of the vehicle via one or more wiring assemblies 58 or harnesses that may extend through an interior passage formed within a body of the mounting assembly 18. An example of a rearview mirror assembly connected to a mounting bracket having a single ball mount similar to that discussed herein is disclosed in U.S. Pat. No. 6,467,919 entitled MIRROR WITH SPLIT BALL MOUNT AND HOLD-OPEN DEVICE, the entire contents of which are hereby incorporated herein by reference.

The carrier plate 38 is located behind and connected to a rear surface 20b of the mirror element 20 and is further connected to the circuit board 40. An example of an interior rearview mirror including a carrier plate and a circuit board is disclosed in U.S. Pat. No. 6,239,899, entitled MIRROR WITH INTERNAL SUPPORT PLATE, the entire contents of which are hereby incorporated herein by reference. In the interior rearview mirror, the carrier plate 38 assists in maintaining the mirror element 20 in position within the housing 14. As previously noted, the housing 14, the carrier plate 38, the circuit board 40, and the mirror element 20 forming an assembly to which the camera apparatus 12 is connected. In some examples, the mirror assembly 10 may also comprise a front bezel as disclosed in U.S. Patent Application Publication No. 2005/0152054 entitled REFLECTIVE ELEMENT HOLDER FOR REARVIEW MIRROR, the entire contents of which are hereby incorporated herein by reference.

In the illustrated example, the circuit board 40 and the mirror element 20 are located adjacent to the carrier plate 38. The carrier plate 38 includes a first face 38a and a second face 38b. The circuit board 40 is located adjacent to the second face 38b of the carrier plate 38. The circuit board 40 includes a first side 40a facing the carrier plate 38 and a second side 40b facing away from the carrier plate 38 into the housing 14. The mirror element 20 is located adjacent to the first face 38a of the carrier plate 38.

In the example provided, the mirror element 20 includes an electrochromic (EC) mirror subassembly formed by a first substrate and a second substrate, which may be formed of glass. Between the first substrate and the second substrate, a sealed cavity is formed and configured to sealably enclose and retain an electro-optic medium. The electro-optic medium may correspond to an electrochromic material disposed in the cavity between the first and second substrates. The Electrochromic material is preferably a solution phase (sometimes called herein a “liquid-phase” or “gel-type”) Electrochromic material, as disclosed in U.S. Pat. No. 4,902,108 entitled SINGLE-COMPARTMENT, SELF-ERASING, SOLUTION-PHASE ELECTROCHROMIC DEVICES, SOLUTIONS FOR USE THEREIN, AND USES THEREOF and U.S. Pat. No. 5,278,693 entitled TINTED SOLUTION-PHASE ELECTROCHROMIC MIRRORS, the entire contents of both of which are hereby incorporated herein by reference. Although the mirror element 20 is illustrated as including the Electrochromic material, it is contemplated that the mirror element 20 could be any type of reflective surface. For example, the mirror element 20 could be a prismatic mirror.

Referring now more specifically to FIG. 3, the mirror assembly 10 may comprise at least one light sensor 60 in communication with the controller 52 via the circuit board 40. The signals from the at least one light sensor may be processed by the controller 52 to control a transmittance of the electro-optic or electrochromic device as discussed herein and may also be utilized to detect lighting conditions and set exposure settings for the imager 50 of the camera apparatus 12. In some instances, the at least one light sensor 60 may include a glare light sensor 60a and an ambient light sensor 60b. In general, the glare sensor 60a may detect light transmitted through a transflective coating of the mirror element 20 that is attributed to glare light typically received from trailing vehicles. The ambient light sensor 60b is utilized to communicate environmental lighting conditions to the controller 52. As shown, the ambient light sensor 60b is directed forward through an aperture 64 formed in the housing 14. In an assembled configuration, the aperture 64 is directed through the front windshield of the vehicle to detect environmental lighting conditions.

The mirror assembly 10 further may include a remote device controller in the form of a trainable transmitter 70. The trainable transmitter 70 comprises a user interface 72 including multiple switches or inputs 74 configured to identify a user input to initiate a transmission from the trainable transmitter 70. In the example shown the trainable transmitter 70 is configured to be connected to the bottom portion 14a of the housing 14 offset from the hood 28 of the camera apparatus 12 toward one of the side portions 14d, 14e. The trainable transmitter 70 may be implemented as a HOMELINK® system operable to “learn” characteristics of multiple control signals. The trainable transmitter 70 may subsequently generate and transmit a signal having the learned characteristics to a remotely controlled device. An example of such a system is disclosed in U.S. Pat. No. 5,854,593. The user interface 72 may correspond to a capacitive touch interface including a plurality of capacitive sensors in communication with the controller 52.

As previously discussed, the camera apparatus 12 may be enclosed within the mirror assembly 10 by the hood 28 in combination with the housing 14. Additionally, the optics of the camera apparatus 12 may be directed through a transflective or transparent panel 75. The panel 75 may be formed of a thin glass substrate or other substantially optically transparent materials. In an exemplary implementation, the panel 75 is formed of a 0.7 mm glass substrate with a transflective coating that disguises or masks the camera apparatus 12 from view. Additionally disposed within the recessed portion 24 of the housing 14 may be an indicator assembly 76. The indicator assembly 76 may comprise a light guide 78 extending from at least one indicator light of the circuit board 40 and a semitransparent cover extending from the housing 14 on a first side 28a and a second side 28b of the hood 28. The indicator assembly 76 may be configured to communicate various signals associated with the security or operation of the vehicle as well as the operation of the trainable transmitter 70.

Referring now to FIG. 4, a block diagram of the mirror assembly 10 is shown. The mirror assembly 10 may comprise the controller 52 in connection with the circuit board 40. The controller 52 may also be in communication with a vehicle control module 84 via a communication bus 86 of the vehicle. The communication bus 86 may be configured to deliver signals to the controller 52 identifying various vehicle states. For example, the communication bus 86 may be configured to communicate to the controller 52 a drive selection of the vehicle, an ignition state, a door open or ajar status, etc. Such information and control signals may be utilized by the controller 52 to activate or adjust various states and/or control schemes of the mirror assembly 10.

The controller 52 may comprise a processor 88 having one or more circuits configured to receive the signals from the communication bus 86 and control the mirror assembly 10. The processor 88 may be in communication with a memory 90 configured to store instructions to control operations of the mirror assembly 10. The controller 52 may further be in communication with the light sensor 60a, 60b, and in some instances may be in communication with a reverse camera or any other form of a vehicle camera system. The controller 52 may receive image data from the reverse camera corresponding to a rearward-directed field of view relative to the vehicle. In this configuration, the mirror assembly 10 may provide for the rearward-directed field of view to be displayed on an integrated display screen. The controller 52 may further be in communication with one or more of a gauge cluster, an audio/video (A/V) system, an infotainment system, a media center, a vehicle computing system, and/or various other devices or systems of the vehicle. In various embodiments, the controller 52 may display image data from imager 50 of the camera apparatus 12 and/or the reverse camera.

In an exemplary embodiment, the controller 52 may correspond to one or more processors or circuits. The controller 52 may be configured to process image data received from the imager 50. In this configuration, the controller 52 may process the image data with one or more algorithms configured to determine an identity or state of awareness of the operator of the vehicle. In cases where the controller 52 associates the image data with the identity of an operator or passenger, the controller 52 may further be operable to control various systems or functions of the vehicle.

In some embodiments, the controller 52 may be in communication with a mobile communication system 100. The mobile communication system 100 may be configured to communicate via various mobile communication protocols. Wireless communication protocols may operate in accordance with communication standards including, but not limited to: Institute of Electrical and Electronic Engineering (IEEE) 802.11 (e.g., Wi-Fi™); Bluetooth®; advanced mobile phone services (AMPS); digital AMPS; global system for mobile communications (GSM); code division multiple access (CDMA); Long Term Evolution (LTE or 4G LTE); local multipoint distribution systems (LMDS); multi-channel-multi-point distribution systems (MMDS); RFID; and/or variations thereof.

The mirror element 20 may be implemented as an electrochromic element or an element, such as a prism. One non-limiting example of an electrochromic element is an electrochromic medium, which includes at least one solvent, at least one anodic material, and at least one cathodic material. Typically, both of the anodic and cathodic materials are electroactive and at least one of them is electrochromic. It will be understood that regardless of its ordinary meaning, the term “electroactive” will be defined herein as a material that undergoes a modification in its oxidation state upon exposure to a particular electrical potential difference. Additionally, it will be understood that the term “electrochromic” will be defined herein, regardless of its ordinary meaning, as a material that exhibits a change in its extinction coefficient at one or more wavelengths upon exposure to a particular electrical potential difference. Electrochromic components, as described herein, include materials whose color or opacity are affected by electric current, such that when an electrical current is applied to the material, the color or opacity change from a first phase to a second phase. The electrochromic component may be a single-layer, single-phase component, multi-layer component, or multi-phase component, as described in U.S. Pat. No. 5,928,572 entitled “Electrochromic Layer And Devices Comprising Same,” U.S. Pat. No. 5,998,617 entitled “Electrochromic Compounds,” U.S. Pat. No. 6,020,987 entitled “Electrochromic Medium Capable Of Producing A Pre-selected Color,” U.S. Pat. No. 6,037,471 entitled “Electrochromic Compounds,” U.S. Pat. No. 6,141,137 entitled “Electrochromic Media For Producing A Pre-selected Color,” U.S. Pat. No. 6,241,916 entitled “Electrochromic System,” U.S. Pat. No. 6,193,912 entitled “Near Infrared-Absorbing Electrochromic Compounds And Devices Comprising Same,” U.S. Pat. No. 6,249,369 entitled “Coupled Electrochromic Compounds With Photostable Dication Oxidation States,” U.S. Pat. No. 6,137,620 entitled “Electrochromic Media With Concentration Enhanced Stability, Process for the Preparation Thereof and Use In Electrochromic Devices,” and U.S. Pat. No. 6,519,072 entitled “Electrochromic Device”; and International Patent Application Publication Nos. WO 98/42796 entitled “Electrochromic Polymeric Solid Films, Manufacturing Electrochromic Devices Using Such Solid Films, and Processes for Making Such Solid Films and Devices,” and WO 99/02621 entitled “Electrochromic Polymer System,” which are herein incorporated by reference in their entirety.

The present disclosure may be used with a mounting system such as that described in U.S. Pat. Nos. 8,814,373; 8,201,800; 8,210,695; 8,925,891; 8,960,629; 9,174,577; 9,244,249; and 9,838,653; and U.S. Provisional Patent Application No. 61/704,869, which are hereby incorporated herein by reference in their entirety. Further, the present disclosure may be used with a rearview packaging assembly such as that described in U.S. Pat. Nos. 8,814,373; 8,646,924; 8,643,931; 8,264,761; 8,885,240; and 9,316,347; and U.S. Provisional Patent Application No. 61/707,625, which are hereby incorporated herein by reference in their entirety. Additionally, it is contemplated that the present disclosure can include a bezel such as that described in U.S. Pat. Nos. 8,827,517; 8,210,695; and 8,201,800, which are hereby incorporated herein by reference in their entirety.

The above description is considered that of the preferred embodiments only. Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

In this document, relational terms, such as first and second, top and bottom, front and back, left and right, vertical, horizontal, and the like, are used solely to distinguish one entity or action from another entity or action, without necessarily requiring or implying any actual such relationship, order, or number of such entities or actions. These terms are not meant to limit the element which they describe, as the various elements may be oriented differently in various applications. Furthermore, it is to be understood that the device may assume various orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It will be understood that any described processes or steps within described processes may be combined with other disclosed processes or steps to form structures within the scope of the present disclosure. The exemplary processes disclosed herein are for illustrative purposes and are not to be construed as limiting. It is also to be understood that variations and modifications can be made on the aforementioned methods without departing from the concepts of the present disclosure, and further it is to be understood that such concepts are intended to be covered by the following claims unless these claims by their language expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within at least one of 2% of each other, 5% of each other, and 10% of each other.

What is claimed is:

1. A mirror assembly for a vehicle comprising:
a housing forming a top portion and a bottom portion extending laterally between two side portions;
a mirror element in connection with and enclosing a front portion of the housing, the mirror element forming a cutout portion extending along one side, the cutout portion forming a notched edge having a notched profile, wherein the bottom portion of the housing forms a recessed portion aligned with the notched profile;
a camera apparatus disposed in a hooded trim panel in connection with the housing and positioned at least partially within the recessed portion of the housing, wherein the recessed portion positions the camera apparatus at least partially within a perimeter profile of the mirror element; and
a lens panel in connection with the hooded trim panel and in front of an optical assembly of the camera apparatus;
wherein the cutout portion extends through the mirror element and the housing from a front surface of the mirror element to a rear surface of the housing.

2. The mirror assembly according to claim 1, wherein the lens panel is of one of a transflective material and a transparent material.

3. The mirror assembly according to claim 1, wherein the lens panel is less than 0.8 mm in thickness.

4. The mirror assembly according to claim 1, wherein the hooded trim panel comprises a hood configured to form a rectangular dome extending from the recessed portion into the cutout portion.

5. The mirror assembly according to claim 1, wherein the cutout portion extends through the mirror element and the housing from a front surface of the mirror element to a rear surface of the housing.

6. A mirror assembly for a vehicle comprising:
a housing forming a top portion and a bottom portion extending laterally between two side portions;
a mirror element in connection with and enclosing a front portion of the housing, the mirror element forming a cutout portion extending along one side, the cutout portion forming a notched edge having a notched profile, wherein the bottom portion of the housing forms a recessed portion aligned with the notched profile; and
a camera apparatus disposed in a hooded trim panel in connection with the housing and positioned at least partially within the recessed portion of the housing, wherein the recessed portion positions the camera apparatus at least partially within a perimeter profile of the mirror element.

7. The mirror assembly according to claim 6, further comprising a lens panel in connection with the hooded trim panel and in front of an optical assembly of the camera apparatus.

8. The mirror assembly according to claim 7, wherein the lens panel is of one of a transflective material and a transparent material.

9. The mirror assembly according to claim 7, wherein the lens panel is less than 2 mm in thickness.

10. The mirror assembly according to claim 9, wherein the lens panel is less than 0.8 mm in thickness.

11. The mirror assembly according to claim 6, wherein the mirror element comprises a transflective electrochromic mirror element configured to vary in reflectance.

12. The mirror assembly according to claim 6, wherein the hooded trim panel comprises a hood configured to form a rectangular dome extending from the recessed portion into the cutout portion.

13. The mirror assembly according to claim 6, wherein the cutout portion extends through the mirror element and the housing from a front surface of the mirror element to a rear surface of the housing.

14. The mirror assembly according to claim 6, wherein an image sensor of the camera apparatus is configured to generate image data, the image data to be processed by a controller.

15. The mirror assembly according to claim 14, wherein the image data is processed in relation to a biometric authentication process.

16. The mirror assembly according to claim 15, wherein the biometric authentication process is one of facial recognition and iris recognition.

17. The mirror assembly according to claim 15, wherein the image data is processed in relation to one of a driver monitoring process and a passenger compartment monitoring process.
